(19) United States
(12) Patent Application Publication
(10) Pub. No.: US 2007/0213083 A1
(43) Pub. Date: Sep. 13, 2007

(54) Wireless Transmission Of Audio Data Encoded by Pulse Width Modulation

(76) Inventor: Tamir Shaanan, Herzlia (IL)

Correspondence Address: JOHN ALEXANDER GALBREATH, 2516 CHESTNUT WOODS CT, REISTERSTOWN, MD, 21136, US

(21) Appl. No.: 11/575,760

(22) PCT Filed: May 30, 2005
(86) PCT No.: PCT/IL05/00557

§ 371 Date: Mar. 22, 2007

Related U.S. Application Data
(60) Provisional application No. 60/656,688, filed on Feb. 25, 2005.

(51) Int. Cl. H04B 7/00

(52) U.S. Cl. 455/500

(57) ABSTRACT

A system for wirelessly transmitting an audio data signal, including a wireless transmitter, and one or more wireless receivers. Wherein the wireless transmitter receives a digital audio data signal, converts it to a pulse width modulated signal and transmits it wirelessly to the one or more wireless receivers; and wherein the wireless transmitter is adapted to transmit to more than one receiver simultaneously.

### RELATED APPLICATIONS

The present application claims the benefit under 35 USC 119(e) of U.S. provisional application 60/656,688 filed on Feb. 25, 2005, the disclosure of which is incorporated herein by reference.

### FIELD OF THE INVENTION

The present invention relates generally to wireless transmission of audio data, and in particular to transmission of audio data encoded by pulse width modulation.

### BACKGROUND OF THE INVENTION

The audio market (home audio entertainment, automotive audio systems, studio audio systems, etc.) has undergone considerable changes in the last few years. The digital revolution, starting with the conversion from analog media, i.e., records and tapes to digital CD and DVD media, is also replacing the large, heavy, and power consuming two-channel analog amplifiers with small, high quality, and power saving multi-channel digital amplifiers.

As of these market changes, it is becoming more common to work with power amplifiers that can receive audio data in the form of a digital pulse width modulated (PWM) signal. The PWM signal is characterized by a relatively high carrier frequency of several hundred kilohertz (with a finite set of predetermined digital voltage levels, e.g. 0V, 5V or 0V, 5V, and −5V) instead of an analog signal (with continuous or semi continuous values). The average of the digital values over a small time interval (dt) represents the analog value for that time interval. Power amplifiers that accept a PWM signal at their input are typically referred to as class D power amplifiers. Class D power amplifiers can thus be defined as amplifiers that operate with all their power stage elements alternating between several discrete states.

The class D amplification approach eliminates the digital to analog converter (DAC) and analog signals in conventional systems, and can increase efficiency by up to a factor of 3 compared to class A or class B designs. Class D eliminates problems with analog noise, as there are no low-level analog signals. With analog designs there is always an input signal present that is amplified through the power stage. In class D only digital and power signals are used, which are much less sensitive to corruption by noise. This simplifies circuit board lo design, and improves audio performance within the high noise environments typically found in digital audio products. Additionally, some class D offerings exhibit sound quality otherwise attainable only with much more expensive means.

Use of power amplifiers that accept a PWM input signal typically increases efficiency from less than 50% to more than 90%. Typically, a speaker is that requires a power input of 100W to deliver a power output of 50W can deliver a 90W output from the same input. Likewise, smaller power amplifiers with a lower power input can be used to produce the same output. As a result, power amplifiers required for a specific power output have a smaller physical volume, lower weight, lower heat dissipation, lower power consumption (resulting for example with a longer battery life time or a reduced consumption from the mains power supply), and low airflow requirements. All these properties add up to vastly expand the product concept and the design freedom.

In home theater in a box (HTiB) and other advanced audio systems it is becoming common practice to place power amplifiers within multiple powered speakers (known as active speakers) that are deployed at various points of a room to create a surround audio sensation. One company that uses this approach for many years is Bang & Olufsen from Denmark. In an audio system using this approach there are 6 or more speakers, part or all of which are active, and which incorporate internal power amplifiers. For example, the 2 front speakers and the center speaker could be passive, while the 2 surround speakers and the subwoofer are powered speakers. In an HTiB system, the audio source, for example a DVD-Receiver or amplifier is generally positioned near the video source at one end of the room, and connected with wires that typically carry a powered signal to passive (non-powered) speakers and/or an audio signal only to the power amplifiers within the powered speakers.

The rapid growth of home theater systems has created the need for wireless audio solutions. The most acute problem is the deployment of wires for the rear surround speakers that are usually located opposite to the audio source device. Generally, installation of the wires is a nuisance for the common user. Simple deployment of the wires without careful preparation could be hazardous and/or an aesthetic inconvenience. On the other hand, a quality installation can be very costly, or limit the user's freedom in selecting the place to deploy such an audio system. In many cases the user chooses to position the speakers according to installation convenience and not in the recommended position by the manufacturer, which would then maximize the sound quality.

Some audio system manufacturers offer wireless speaker systems, which use various transmission methods, such as Infrared (IR) or Radio-Frequency (RF) to transmit audio data to one or more powered speakers.

U.S. Pat. No. 4,959,828 to Austin, the disclosure of which is incorporated herein by reference, describes a multi-channel infrared cable-less communication system for simultaneously transmitting a plurality of audio signals from at least one transmission point to one or more reception points.

U.S. Pat. No. 6,671,325 to Lee et al., the disclosure of which is incorporated herein by reference, describes a wireless infrared audio system for transmitting digitized samples of analog signals.

U.S. patent publication 2004/0242242 to Wu et al., the disclosure of which is incorporated herein by reference, describes a half duplex wireless audio communication system based on RF transmissions.

Generally, a wireless audio system accepts either analog audio data or digital audio data for transmission to a wireless receiver. The wireless receiver is typically incorporated within a powered speaker or embedded within an external accessory that is attached to the speaker, either passive or active. Typically, the analog audio data is converted to a digital representation by pulse code modulation (PCM). The digital representation of the audio data is transferred to a wireless transmitter, which transmits it to a receiving station. The receiving station uses a D/A (digital to analog) converter to convert the audio data from PCM back to analog representation to supply the audio signal to an analog power amplifier, typically of class A or B.

In order to supply the audio data to a class D amplifier the receiving station needs to convert the PCM data to PWM data before supplying it to the class D amplifier.

U.S. Pat. No. 5,815,298 to Cern, the disclosure of which is incorporated herein by reference, describes a system and method for wirelessly communicating a sound signal. In the system two transceivers are positioned facing each other and accurately aligned to transmit and receive light signals that are aimed from one to the other. Audio data is converted to PWM data and transmitted as a PWM signal by turning on and off a light source responsive to the PWM data.

### SUMMARY OF THE INVENTION

An aspect of an embodiment of the invention relates to a system and method of transmitting audio data from a transmitting station to one or more receiving stations using wireless modems, wherein the audio data is converted to digital PWM data before being transmitted via the wireless transmit modem. As a result, once the transmitted data is demodulated by the wireless receive modem, residing in the receiving station, it can be delivered to an amplifier that receives a PWM digital signal at its input, without additional conversions.

In some embodiments of the invention, the wireless transmit and receive modems use radio frequency transmissions. Alternatively, these wireless modems use infrared transmissions or other wireless methods of transmission.

In some embodiments of the invention, the transmitting station transmits an audio signal carrying time division or frequency division multiplexed data for a few receiving stations. Optionally, each receiving station discards data that is not needed by the receiving station, i.e., extracts only that audio signal intended for it.

There is thus provided according to an exemplary embodiment of the invention, a system for wirelessly transmitting an audio data signal, including a wireless transmitter, one or more wireless receivers, wherein the wireless transmitter receives a digital audio data signal, converts the digital audio data signal to a pulse width modulated signal and transmits the pulse width modulated signal wirelessly to the one or more wireless receivers, and wherein the wireless transmitter is adapted to transmit to more than one wireless receiver simultaneously.

Optionally, the system includes at least two wireless receivers. In some embodiments of the invention, the wireless transmitter uses RF technology. Alternatively, the wireless transmitter uses infrared technology. In some embodiments of the invention, the wireless transmitter uses RF and infrared technologies. Optionally, the wireless transmitter transmits multiple channels of audio data. In some embodiments of the invention, each of the one or more wireless receivers accepts a single channel of audio data. Optionally, some of the one or more wireless receivers accept multiple channels of audio data. In some embodiments of the invention, some of the one or more wireless receivers accept the same channel of audio data. Optionally, each of the one or more wireless receivers accepts distinct channels of audio data.

In some embodiments of the invention, the system includes a switch on the one or more wireless receivers to preset the channel which is accepted by the wireless receiver. Optionally, the channel accepted by the one or more wireless receivers is selected by a powered speaker, which receives the signal from the wireless receiver. In some embodiments of the invention, the wireless transmitter transmits each channel using a distinct frequency. Optionally, the wireless transmitter transmits each channel using a distinct electronic frequency. In some embodiments of the invention, the wireless transmitter transmits each channel using a distinct optical frequency. Optionally, the wireless transmitter transmits each channel using a distinct time frame.

In some embodiments of the invention, the system includes one or more powered speakers, which produce an audio output using the pulse width modulated signal received by the one or more wireless receivers. Optionally, at least one of the one or more wireless receivers supplies an audio signal to more than one powered speaker. In some embodiments of the invention, at least one of the one or more wireless receivers is embedded in an encasement of a powered speaker. Optionally, at least one of the one or more wireless receivers is not embedded in an encasement of a powered speaker.

In some embodiments of the invention, the system includes a device for supplying an audio signal, wherein the wireless transmitter is embedded in the device. Optionally, the system includes a device for supplying an audio signal, wherein the wireless transmitter is not embedded in the device. In some embodiments of the invention, the wireless transmitter compresses the pulse width modulated signal before transmission. Optionally, the wireless receiver decompresses the pulse width modulated signal after reception. In some embodiments of the invention, the pulse width modulated signal is transmitted in a modulated form.

There is thus further provided according to an exemplary embodiment of the invention, a method of wirelessly transmitting an audio data signal to powered speakers, including accepting a digital audio signal, converting the digital audio signal to a pulse width modulated signal, modulating the pulse width modulated signal for wireless transmission of the signal, transmitting the modulated signal to one or more wireless receivers, demodulating the received signal at the one or more wireless receivers, transferring the demodulated signal to one or more power amplifiers. In some embodiments of the invention, the method further includes compressing the pulse width modulated signal before modulation; and decompressing the received signal after demodulation.

### BRIEF DESCRIPTION OF THE DRAWINGS

The present invention will be understood and appreciated more fully from the following detailed description taken in conjunction with the drawings. Identical structures, elements or parts, which appear in more than one figure, are generally labeled with a same or similar number in all the figures in which they appear, wherein:

FIG. 1 is a schematic illustration of a system with wireless powered speakers driven by PWM audio data, according to an exemplary embodiment of the invention.

FIG. 2 is a schematic block diagram of a wireless transmitting station and wireless receiving stations for supplying audio data to power amplifiers within powered speakers driven by PWM audio data, according to an exemplary embodiment of the invention.

### DETAILED DESCRIPTION

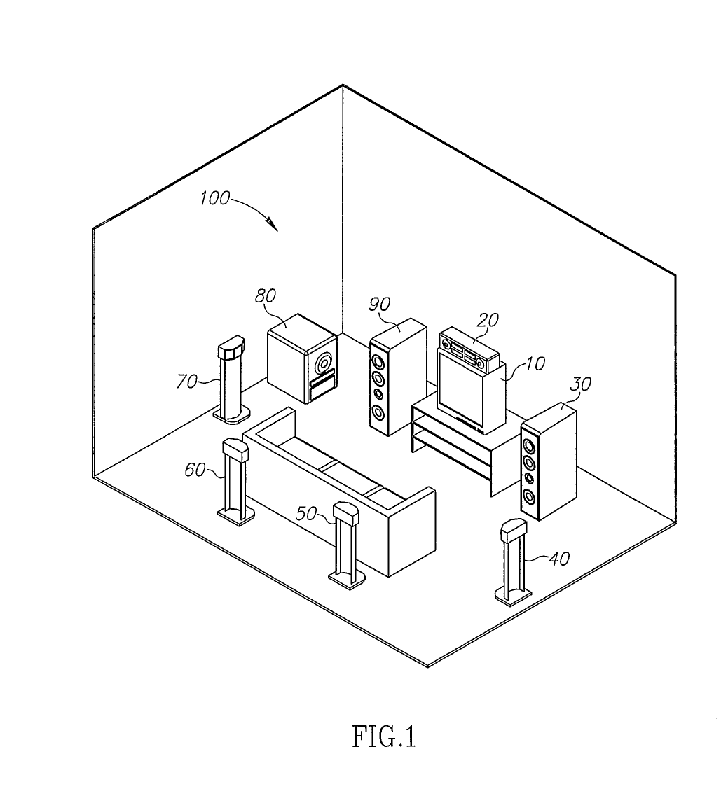

FIG. 1 is a schematic illustration of a system 100 with wireless powered speakers incorporating power amplifiers driven by PWM audio data, according to an exemplary embodiment of the invention. In an exemplary embodiment of the invention, a device 10, which generates an audio signal, is situated in the front of a room or enclosure. As an example, device 10 may be the video or DVD-Receiver of a home theater system, an amplifier, a television, a computer, a plasma/LCD TV, a game station, a juke box or any other system, which generates an audio signal. In an exemplary embodiment of the invention, the audio signal is wirelessly transmitted to one or more powered speakers to output the audio signal to the air medium. Optionally, the powered speakers may be close to device 10 or in a different location in the room, for example on the opposite side of the room. In an exemplary embodiment of the invention, the powered speakers receive the audio signal using a wireless communication link, for example using infrared or RF technology. Optionally, some of the powered speakers (e.g. the ones close to device 10) are connected with wires and some are connected with a wireless connection. Alternatively, all the powered speakers are connected with a wireless connection. In some embodiments of the invention some of the powered speakers use one type of wireless connection (e.g. infrared) and others use a different type of wireless connection (e.g. RF). Optionally, the type of connection is selected dependent on the powered speakers' location, which can be inside the room or outside of it, for example in another room or outside, in a garden or other area.

FIG. 1 illustrates an exemplary system 100 with 8 powered speakers, generally referred to as a 7.1 Dolby Digital system. As shown in FIG. 1 one powered speaker 20 is located in the center above device 10. Two powered speakers 90 and 30 are located on the right and left sides of device 10 respectively (the front speakers). Two powered speakers 70 and 40 are located in the middle of the room on the right and left sides respectively. Two powered speakers 60 and 50 are located in the back of the room on the right and left sides behind the listeners, and one subwoofer powered speaker 80 is located in the room on the left near the front powered speaker. The position of the powered speakers is of importance for producing certain sound effects.

In some embodiments of the invention, each powered speaker receives an audio signal from a different channel. Alternatively, some of the powered speakers or all of them receive the same channel.

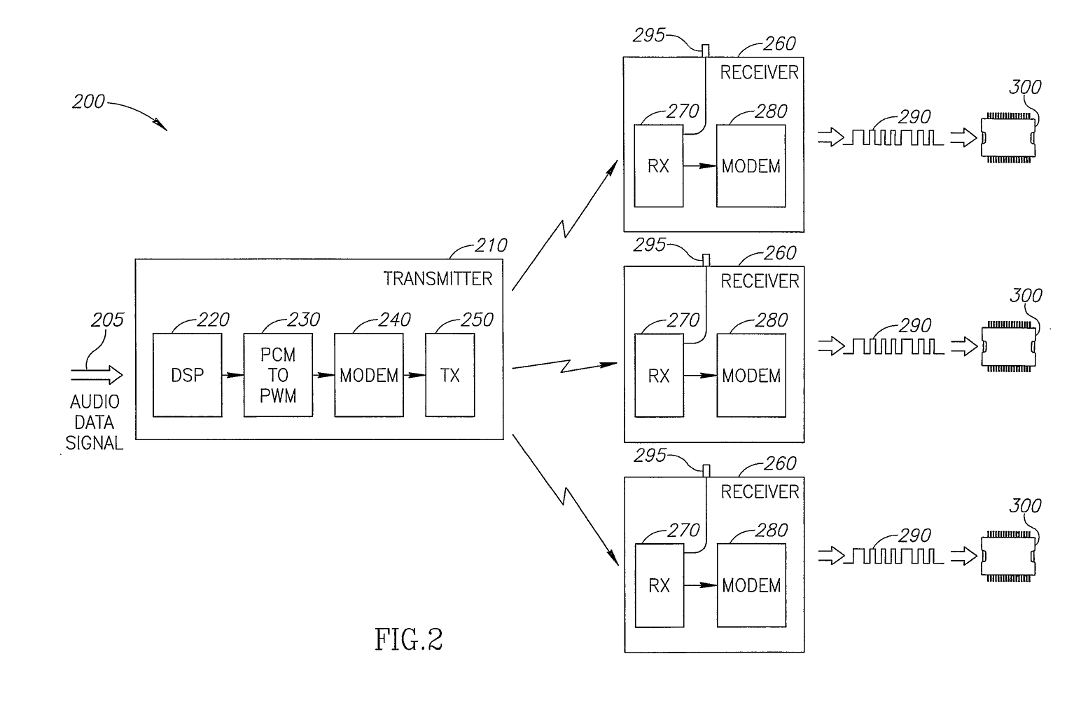

FIG. 2 is a schematic block diagram 200 of a wireless transmitter 210 and wireless receivers 260 for supplying audio data to one or more powered speakers driven by PWM audio data, according to an exemplary embodiment of the invention.

In an exemplary embodiment of the invention, an audio data signal 205 is supplied to wireless transmitter 210. Optionally, audio data signal 205 from the audio source is supplied to wireless transmitter 210 as a digital audio signal (e.g. in pulse code modulation (PCM) format). Alternatively, an analog to digital converter is added to the input of wireless transmitter 210 in order to accept an analog audio data signal and convert it to a digital signal. In an exemplary embodiment of the invention, the audio data signal 205 may comprise audio data of a single channel, or of multiple channels to play different audio data with different powered speakers. Optionally, wireless transmitter 210 incorporates a digital signal processor (DSP) 220, which accepts audio signal 205 and performs various manipulations on the signal, for example controlling volume, bass, equalization and/or gain, mixing different channels and the like. The manipulations may be responsive to instructions from the user (via, for example, a remote control) or automatic manipulations for the purpose of signal enhancement. An example of a chip that can be used for DSP 220 is TAS3103 from Texas Instruments.

In an exemplary embodiment of the invention, the signal from DSP 220 is transferred to a PCM to PWM converter 230 in order to convert the audio data signal to PWM format, so that it may be eventually supplied on the receiving station to power amplifiers that accept a PWM signal (e.g. class D amplifiers).

PCM to PWM converters are offered by many companies, for example: Apogee Technology Inc. (www.apogeeddx.com) produces a chip termed DDX-8001, Texas Instruments Inc. (www.ti.com) produces chips termed TAS5504, TAS5518, TAS5086 and TAS5508.

Many companies also offer class D amplifiers, for example: Apogee offers: DDX2050, DDX2100, and DDX2160. Texas Instruments offers: TAS5186, TAS5142, and TAS5152. Some manufacturers offer a single chip, which incorporates DSP 220 and PCM to PWM converter 230, for example TAS5518 by Texas Instruments.

Optionally, the PWM signal is transferred to a transmit modem 240 where it is modulated for transmission by a wireless transmitter front-end 250. In some embodiments of the invention, wireless transmitter front-end 250 uses RF technology or infrared technology or other wireless transmission method, each of which are able to transfer a modulated audio signal of PWM format.

In an exemplary embodiment of the invention, receiver 260 comprises a wireless receiver front-end 270 and a receive modem 280. Optionally, wireless receiver front-end 270 accepts the signals transmitted by wireless transmitter 210 and receive modem 280 demodulates the signals resulting in an audio signal 290 in PWM format. Optionally, audio signal 290 is supplied to a class D power amplifier 300 (for example apogee DDX-2060) to power a powered speaker.

In some embodiments of the invention, wireless transmitter 210 transmits a signal comprising multiple channels. Optionally, wireless transmitter 210 differentiates between the channels in its transmission, for example using different frequencies (e.g. electronic or optical) for each channel or using different time slices in a time sharing scheme (TDM—Time Division Multiplexing). Optionally, multiple wireless receivers 260 are preset to accept one or more channels of the overall wirelessly transmitted audio channels.

In some embodiments of the invention, wireless receiver 260 comprises a switch 295 for selecting the channel it will receive, for example which number powered speaker it represents of powered speakers 20 to 90 as shown in FIG. 1. Alternatively wireless receiver 260 may be hard wired to represent a specific powered speaker with a specific task (for example the left rear surround powered speaker). In some embodiments of the invention, the wireless receiver is programmable by other methods, for example by connecting it to a computer or another intelligent accessory for programming, or by receiving a command from a wireless controller. In some embodiments of the invention, the wireless receiver may be preset by querying the powered speaker it is connected to, to determine the channel it needs to receive.

In some embodiments of the invention, each wireless receiver uses a single channel to power one or more powered speakers. Alternatively or additionally, a single receiver can accept more than one channel of data and power more than one powered speaker.

In some embodiments of the invention, wireless receiver 260 accepts the audio signals for all channels and discards the data that is not needed by the specific receiver.

In some embodiments of the invention, multiple wireless transmitters are used, wherein each wireless transmitter transmits an audio signal for one or more channels.

In some embodiments of the invention, the wireless transmitter and receivers are embedded in other parts of a system, for example the wireless receivers 260 are embedded in the encasement of the powered speakers and the wireless transmitter 210 is embedded in the encasement of the video device or audio source (e.g. a plasma TV, LCD screen, computer, DVD, MP3 player, game station, juke box). Alternatively, some of the wireless receivers 260 or wireless transmitters 210 are embedded and some are within an external encasement or accessory device.

In an exemplary embodiment of the invention, a pair comprising wireless transmitter 210 and wireless receiver 260 are used to replace a wire in a prior art cable based class D power amplifier system.

Optionally, by placing converter 230 in wireless transmitter 210 instead of in wireless receivers 260 or after wireless receivers 260, the conversion to PWM is performed at only one point in the overall signal track, and delivered to all wireless receivers 260, thus simplifying the architecture of the wireless receivers and/or reducing their cost.

In prior art systems generally a PCM signal is transmitted by wireless transmitter front-end 250 to wireless receiver front-end 270. The PCM signal is a simple synchronous signal typically comprising a constant amount (e.g. 16-24) of equal sized time slices representing audio bits, with a constant bit time. In contrast a PWM signal is an irregular signal of varying pulse width, thus the transfer of PWM would typically require a modem that can sample the incoming PWM input signal at a high frequency in order to accurately represent the PWM signal. A typical chip that converts a PCM signal to PWM may function at a rate of up to 100 MHZ, for example in chips offered by Apogee Technology Inc. (mentioned above). Optionally, sampling the signal at 100 MHz would give satisfactory results in representation of the PWM signal. Each sampling event typically results in one bit (either 0 or 1, corresponding to two discrete voltage levels), therefore a 100MHz signal would result in the transfer of approximately 100 MBPS.

In an exemplary embodiment of the invention, transmit modem 240, wireless transmitter front-end 250 and likewise receive modem 280 and wireless receiver front-end 270 are selected to function at similar rates to prevent degradation of the PWM signal. It should be noted that lower processing rates could be used at the expense of the accuracy of the signal and its resulting quality. An example of a chip that supports transmission of a signal at such rates using RF is UB501 that is offered by Wisair LTD (www.wisair.com). The Wisair chip incorporates Ultra Wide Band (UWB) technology that supports high transfer rates (e.g. to transfer 50 to 500 MBPS). Additionally, wireless network systems incorporating IEEE 802.11g support the transfer of 54 MBPS or even 2 times that (i.e. 108 MBPS) in current implementations.

Wireless transmission of 100 MBPS using infrared is also known in the art, for example as described by J. M. Kahn from Berkley University (“High-Speed Wireless Infrared Communication”, final report 1996-97 for MICRO project 96-001 Sponsored by Hewlett-Packard) the disclosure of which is incorporated herein by reference.

In some embodiments of the invention, transmit modem 240 compresses the sampled PWM signal before transmission in order to reduce the amount of data being transmitted. On the receiver side receive modem 250 decompresses the data to recover the original signal. Optionally, a standard lossless compression scheme can be used, for example run-length encoding. Typically, for a PWM signal that requires a transmission rate of 100MBPS, the data can be reduced on the average by a factor of 50%, 70%, 90% or more. Optionally, modems with slower transmission rates can be used (e.g. 4 MBPS, 10 MBPS) to transfer the PWM signal, thus reducing the cost of the modem.

In some embodiments of the invention, transmit modem 240 and receive modem 250 are integrated chips, which perform compression as part of their built in functions. Alternatively, transmit modem 240 and receive modem 250 may comprise a circuit with components for dealing with compression.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the invention. Further combinations of the above features are also considered to be within the scope of some embodiments of the invention.

Section headings are provided for assistance in navigation and should not be considered as necessarily limiting the contents of the section.

It will be appreciated by persons skilled in the art that the present invention is not limited to what has been particularly shown and described hereinabove. Rather the scope of the present invention is defined only by the claims, which follow.

1. A system for wirelessly transmitting an audio data signal, comprising:
a wireless transmitter;
one or more wireless receivers;
wherein said wireless transmitter receives a digital audio data signal, converts the digital audio data signal to a pulse width modulated signal and transmits the pulse width modulated signal wirelessly to the one or more wireless receivers; and
wherein said wireless transmitter is adapted to transmit to more than one wireless receiver simultaneously.

2. A system according to claim 1, comprising at least two wireless receivers.

3. A system according to claim 1, wherein said wireless transmitter uses RF technology.

4. A system according to claim 1, wherein said wireless transmitter uses infrared technology.

5. A system according to claim 1, wherein said wireless transmitter uses RF and infrared technologies.

6. A system according to claim 1, wherein said wireless transmitter transmits multiple channels of audio data.

7. A system according to claim 6, wherein each of said one or more wireless receivers accepts a single channel of audio data.

8. A system according to claim 6, wherein some of said one or more wireless receivers accept multiple channels of audio data.

9. A system according to claim 6, wherein some of said one or more wireless receivers accept the same channel of audio data.

10. A system according to claim 6, wherein each of said one or more wireless receivers accepts distinct channels of audio data.

11. A system according to claim 6, further comprising a switch on said one or more wireless receivers to preset the channel which is accepted by the wireless receiver.

12. A system according to claim 6, wherein the channel accepted by the one or more wireless receivers is selected by a powered speaker, which receives the signal from the wireless receiver.

13. A system according to claim 6, wherein said wireless transmitter transmits each channel using a distinct frequency.

14. A system according to claim 6, wherein said wireless transmitter transmits each channel using a distinct electronic frequency.

15. A system according to claim 6, wherein said wireless transmitter transmits each channel using a distinct optical frequency.

16. A system according to claim 6, wherein said wireless transmitter transmits each channel using a distinct time frame.

17. A system according to claim 1, comprising one or more powered speakers, which produce an audio output using the pulse width modulated signal received by the one or more wireless receivers.

18. A system according to claim 17, wherein at least one of said one or more wireless receivers supplies an audio signal to more than one powered speaker.

19. A system according to claim 1, wherein at least one of said one or more wireless receivers is embedded in an encasement of a powered speaker.

20. A system according to claim 1, wherein at least one of said one or more wireless receivers is not embedded in an encasement of a powered speaker.

21. A system according to claim 1, comprising a device for supplying an audio signal, wherein said wireless transmitter is embedded in the device.

22. A system according to claim 1, comprising a device for supplying an audio signal, wherein said wireless transmitter is not embedded in the device.

23. A system according to claim 1, wherein said wireless transmitter compresses the pulse width modulated signal before transmission.

24. A system according to claim 23, wherein said wireless receiver decompresses the pulse width modulated signal after reception.

25. A system according to claim 1, wherein said pulse width modulated signal is transmitted in a modulated form.

26. A method of wirelessly transmitting an audio data signal to powered speakers, comprising:
accepting a digital audio signal;
converting the digital audio signal to a pulse width modulated signal;
modulating the pulse width modulated signal for wireless transmission of the signal;
transmitting the modulated signal to one or more wireless receivers;
demodulating the signal received at the one or more wireless receivers;
transferring the demodulated signal to one or more power amplifiers.

27. A method according to claim 26, further comprising: compressing said pulse width modulated signal before modulation; and decompressing said received signal after demodulation.
